(19) United States
(12) Patent Application Publication
(10) Pub. No.: US 2026/0042253 A1
(43) Pub. Date: Feb. 12, 2026

(54) HIGHLY DISPERSED, HIGHLY FILLED, LOW VISCOSITY COMPOSITIONS, METHODS OF MAKING THEREOF, AND USES THEREOF

(71) Applicant: Azul 3D, Inc., Skokie, IL (US)

(72) Inventors: Philip Oweimrin, Skokie, IL (US); James Hedrick, Skokie, IL (US); Richard Schmidt, Skokie, IL (US); David Walker, Skokie, IL (US)

(21) Appl. No.: 19/104,271

(22) PCT Filed: Aug. 18, 2023
(86) PCT No.: PCT/US2023/030578

§ 371 Date: Feb. 17, 2025

Related U.S. Application Data
(60) Provisional application No. 63/398,896, filed on Aug. 18, 2022.

(51) Int. Cl. B29C 64/165; B29C 71/02; B29K 105/00; B29K 105/16; B33Y 10/00; B33Y 40/20; B33Y 70/10; C08K 3/36

(52) U.S. Cl. CPC B29C 64/165; B29C 71/02; B33Y 10/00; B33Y 40/20; B33Y 70/10; C08K 3/36; B29K 2105/0032; B29K 2105/005; B29K 2105/0064; B29K 2105/0094; B29K 2105/162; B29K 2995/0041; C08K 2201/005

(57) ABSTRACT

Highly dispersed, highly filled, low viscosity liquid compositions and uses thereof. A composition can include a carrier fluid, a plurality of nano- and micro-sized particles, and multiple dispersants. A carrier fluid can comprise nonpolar organic liquids. A plurality of particles can comprise inorganic particles. A portion of dispersants can exhibit different association affinities for nano-versus micro-sized particles. A composition can be free of water, other solvents, or diluents. A composition can comprise 30 weight % or greater of particles. A composition can exhibit a consistent viscosity of about 1000 centipoise or lower at about 25° C. A curable composition can comprise curable carrier fluids, such as, for example, monomers and/or oligomers. A composition can be utilized in chemical processing, microfluidics, colloidal fluids, 3D printing, coatings, and other types of additive manufacturing. An object can be made, for example, by vat polymerization 3D printing of one or more curable composition(s).

### CROSS-REFERENCE TO RELATED APPLICATIONS

This application claims the benefit of U.S. Provisional Application No. 63/398,896, filed Aug. 18, 2022. The entire contents of the above-identified applications are hereby fully incorporated herein by reference.

### TECHNICAL FIELD

The subject matter disclosed herein is generally directed to highly dispersed, highly filled, low viscosity compositions comprising one or more carrier fluid(s), a plurality of nano- and micro-sized inorganic particles, and two or more dispersant(s), at least a portion of which exhibit different association affinities for inorganic particles of a particular size or size range particularly, liquid resin compositions, more particularly, three-dimensional (3D) printing compositions; methods of making objects from said compositions, preferably, 3D printed objects, more preferably objects comprising polymer(s), flame retardant(s), ceramic(s), metal(s), or any combination thereof.

### SUMMARY

In an aspect, the present invention provides a highly dispersed, highly filled, low viscosity liquid composition comprising a non-polar organic carrier fluid, a plurality of nano- and micro-sized inorganic particles, and multiple dispersants, at least a portion of which exhibit different association affinities for inorganic particles of a particular size or size range, and wherein the composition is substantially or completely free of water or other solvents and diluents. In an example embodiment, the composition comprises between at least about 30 weight % (wt. %) to about 90 wt. % of the plurality of inorganic particles based on the total weight of the composition and a viscosity of from about 200 centipoise (cP) to about 1000 cP at 250° C. In an example embodiment, the viscosity of the composition is from about 300 cp to about 500 cp at 250° C.

In an example embodiment, the composition comprises a weight ratio of the micro-sized inorganic particles to the nano-sized inorganic particles of from at least about 1/1 to at least about 10/1, from at least about 1/1 to at least about 6/1, or from at least about 1/1 to at least about 2.5/1. In an example embodiment, the plurality of nano- and micro-sized inorganic particles comprise a substantially spherical geometric shape and at least at least a portion of which are in crystalline form. In an example embodiment, the micro-sized inorganic particles comprise an average particle size of from about 0.1 micron (mm) to about 100 mm, from about 0.25 mm to about 75 mm, from about 0.5 mm to about 50 mm, from about 0.75 mm to about 25 mm, from about 1 mm to about 10 mm, or from about 1 mm to about 20 mm; and the nano-sized inorganic particles comprise an average particle size of from about 0.1 nanometers (mm) to about 150 nm, from about 0.25 nm to about 100 nm, from about 0.5 nm to about 50 nm, from about 0.75 nm to about 40 nm, from about 1 nm to about 30 nm, or from about 10 nm to about 40 nm.

In an example embodiment, the nano-sized and the micro-sized inorganic particles independently comprise one or more ceramic(s) or precursor(s) thereof. In an example embodiment, the one or more ceramic(s) comprise, silicon dioxide, aluminum oxide, zirconium dioxide, or any combination thereof. In an example embodiment, the composition further comprises acrylate monomers. In an example embodiment, the nanoparticle- and the microparticle-sized inorganic particles independently comprise(s) one or more nonmetal oxide(s), one or more metal oxide(s), one or more flame retardant(s), one or more metal(s), or any combination thereof. In an example embodiment, the nonmetal and/or metal oxide(s) is/are chosen from silicon dioxide, aluminum oxide, zirconium dioxide, and any combination thereof. In an example embodiment, the metal(s) is/are chosen from stainless steel, copper, aluminum, titanium, and any combination thereof. In an example embodiment, the flame retardant(s) is/are chosen from metal mono-, di-, and tri-hydroxide(s), metal organic phosphorus compound(s), and any combination thereof. In an example embodiment, flame retardant(s) is/are chosen from aluminum trihydroxide, aluminum diethyl phosphinate, melamine zinc polyphosphate, and any combination thereof.

In an example embodiment, at least one dispersant has a higher association affinity for nanoparticle-sized inorganic particles and at least one dispersant has a higher association affinity for microparticle-sized inorganic particles. In an example embodiment, the at least one dispersant having a higher association affinity for nanoparticle-sized inorganic particles, and the at least one dispersant having a higher association affinity for microparticle-sized inorganic particles each individually comprise: a polar group selected based on the association affinity for the nanoparticle- or microparticle-sized inorganic particle; a nonpolar group selected for miscibility with the organic carrier fluid; and a linking group connecting the polar group and the nonpolar group. In an example embodiment, the length of each dispersant is selected, at least in part, to increase steric hindrance between the inorganic particles. In an example embodiment, the polar group(s) is/are independently chosen from alkoxysilane, poly(alkylene glycol), and phosphate ester polar group(s), wherein the nonpolar group(s)) is/are independently chosen from alkyl and vinyl nonpolar group(s), and/or wherein the linking group of the dispersant(s) and/or the surfactant(s) is/are independently chosen from aryl ether and alkyl ester linking group(s).

In an example embodiment, at least one dispersant is selected to stabilize electrostatic and/or steric repulsion of the inorganic particles and/or other dispersants, optionally a phosphodiester polymer. In an example embodiment, the composition further comprises one or more surfactants. In an example embodiment, the composition comprises a weight ratio of the inorganic particles to the dispersant(s) of from about 1/1 to about 10/1, from about 2/1 to about 8/1, or from about 4/1 to about 6/1. In an example embodiment, the carrier fluid comprises one or more organic monomer(s), one or more organic oligomer(s), or any combination thereof.

In an example embodiment, the composition is photocurable and further comprises one or more photo-initiators. In an example embodiment, the composition further comprises one or more photo-stabilizers. In an example embodiment, the composition is thermocurable and comprises one or more thermal initiators. In an example embodiment, the composition further comprises one or more defoamer(s). In an example embodiment, the composition further comprises one or more pigments or coloring agent.

In an aspect, the present invention provides a highly dispersed, highly filled, low viscosity resin composition comprising: a) a non-polar organic carrier fluid comprising curable organic monomers, curable organic oligomers, or combinations thereof; b) a plurality of nanoparticle- and microparticle-sized inorganic particles comprising between at least 30 wt. % to about 90 wt. % based on the total weight of the composition; and c) multiple dispersants comprising a methylacrylated silane, a polyethylene glycol and a phosphodiester polymer; and wherein the composition has a viscosity from about 200 cP to about 1000 cP at 250° C. and is substantially or completely free of water or other solvents and diluents.

In an example embodiment, the non-polar organic carrier comprises CFTA, HDDA, vinylmethoxysiloxane, or a combination thereof. In an example embodiment, the plurality of inorganic particles comprise ceramics or precursors thereof and further comprising an acrylic monomer. In an example embodiment, the ceramic precursors comprise silicon dioxide, aluminum oxide, zirconium dioxide, and any combination thereof. In an example embodiment, the plurality of inorganic particles comprises one or more nonmetal oxide(s), one or more metal oxide(s), one or more flame retardant(s), one or more metal(s), or any combination thereof. In an example embodiment, the nano-sized inorganic particles are fumed silicone dioxide and wherein the micro-sized inorganic particles are fused silicon dioxide in crystalline form and having a spherical geometric shape, optionally 2-6 mm in diameter.

In an example embodiment, the composition comprises a weight ratio of the phosphodiester polymer to a poly(ethylene glycol) of from at least about 1/1 to at least about 10/1, from at least about 1/1 to at least about 6/1, or from at least about 1/1 to at least about 2.5/1; and/or at least 60 wt. % to at least 95 wt. % of methacrylated silane based on the total weight of the dispersant.

In an aspect, the present invention provides a method of making an object, the method comprising: forming one or more layer(s) comprising one or more compositions(s) of the present invention; optionally mixing, dispersing, and/or milling the composition(s) prior to and/or during the forming of one or more or all of the layer(s); solidifying the layer(s); and optionally, sintering the solidified layer(s), wherein an object is formed. In an example embodiment, the forming the layer(s) comprises coating or printing the composition(s) in the form of one layer and, optionally, repeating the coating or the printing the composition(s) to form multiple layers. In an example embodiment, the step of forming the one or more layer(s) comprises vat polymerization three-dimensional (3D) printing. In an example embodiment, the solidifying the layer(s) comprises thermal curing or ultra-violet (UV) radiation curing of the layer(s). In an example embodiment, the object comprises inorganic-polymer composite(s), metal-polymer composite(s), flame retardant-polymer composite(s), ceramic(s), metal(s), or any combination thereof.

In an aspect, the present invention provides an object, wherein the object comprises one or more composition(s) of the present invention and/or wherein the object is prepared by any one of the methods of the present invention. In an example embodiment, the object is in the form of a coating, a sheet, a film, a fiber, a textile, a solid article, a hollow article, a foam, or a composite. In an example embodiment, the object is a consumer product, an industrial product, a medical product or device, an architectural part, an automotive part, an aviation part, a construction part, or an electronics part.

### BACKGROUND

In the field of resin development, formulations are developed with specific material properties in mind. There are an endless number of ways to design formulations for a defined set of properties and characteristics. A category of resins in the current state-of-the-art are liquid based, meaning almost all materials included in the formulation are a liquid, and after they are mixed, the liquid form is maintained at a certain viscosity. Only after an outside stimulus, such as ultraviolet (UV) light, does the material begin to harden to create a solid material. Highly filled resins, or slurries, are a category of liquid-based resins that include a large percent of solid particles of various sizes mixed and dissolved into the liquid portion of the resin. Examples of particles commonly used in highly filled resins include, but are not limited to, silicone oxide (SiO₂), alumina oxide (Al₂O₃), zirconia oxide (ZrO₂), or flame retardant materials. Highly filled resins can provide unique material properties for a wide range of applications including, but not limited to, vat polymerization three-dimensional (3D) printing, composite material development, and coatings. A highly filled resin is conventionally defined as any resin that is 30% or higher solid filler material by weight.

Even though highly filled resins can provide beneficial mechanical properties and thermal stability in a final product, difficulties in processing and manufacturing these types of resins are evident. For highly filled resins, it is crucial that the resin is filled with the proper amount of solid material in order to achieve the desired properties in the final product. A change in percentage of the solid material can significantly change the properties of both the liquid resin itself and the final product in a way that differs from the desired properties. A crucial property of any liquid resin is its viscosity. As the percentage of solid material in the liquid resin increases, the viscosity of the resin will exponentially increase after a critical point. This increase in viscosity can cause difficulties in the processibility of the material, especially in applications that require a resin with high flowing characteristics. Such is the case in liquid-based 3D printing, composites applications, or coating applications (e.g., lay-up coating processes).

In the field of 3D-printing and, more generally, any additive manufacturing method that cures resin or ink such as vat polymerization, it is highly desirable to have 3D printed parts print at a fast enough speed for efficient manufacturing at large scales. The viscosity of the liquid resin is a key factor for print speeds. In vat polymerization, liquid resin is cured into a solid product and moved away from the interface, which allows additional liquid resin to flow to the interface to be cured. A lower viscosity resin can be printed quickly because it is able to quickly flow and replace cured resin as the printed part moves away from the interface. A higher viscosity resin can limit printing speeds as the time needed for the resin to flow into the printing bed increases as viscosity increases. At a certain point, the viscosity of the liquid resin becomes the limiting factor for print speed as the resin flows to replace cured resin at a slower rate than the resin is being cured. This will ultimately limit how fast printing can occur. Another factor to be considered is that the viscosity of the material increases exponentially as more solid particles are added into the resin. This further complicates the amount of filler that can be added at higher percentages.

Centipoise (cP) is the standard measurement for viscosity of liquid resins. Examples of highly filled resins include those developed by Tethon3D. The viscosity of such resins, on the lower end, is 1,000 cP at room temperature (about 25° C.), and a highly viscous resin would be 2,000 to 13,000 cP at room temperature. These are just a few examples for highly filled products. Most highly filled resins of 40-50% or more filler in the current field are highly viscous. Therefore, it would be desirable to develop a method for highly filled resins, or “slurries”, of over 40-50% by weight of solid particles with respect to the total weight of the filled resin with viscosities below 1,000 cP at room temperature.

Highly viscous, highly filled resins also lead to issues with the distribution of the particles in the liquid resin. Non-uniform distribution of particles can increase the viscosity of the resin, and it can cause agglomeration and sedimentation of the filler particles. Further, a poorly uniform resin also leads to inconsistent material properties in its applications as the filler provides most of the physical properties. Consistent material properties are ideal in applications such as 3D printing, composites, coatings, or other additive manufacturing applications. In the current field, methods have been developed to decrease the viscosity of highly filled resins. At a given weight percent of solid particles in a highly filled resin, a resin with a more uniform dispersion of solid particles will have a lower viscosity than a resin with a less uniform dispersion of particles. One method of ensuring uniform distribution of particles is the use of chemical and mechanical methods to mix, disperse, and stabilize solid particles in liquid resins to address these particle distribution issues. The dispersing of particles of one substance into another substance on a microscopic level is defined as “colloidal chemistry” as shown in FIG. 1.

Another state-of-the-art method for creating a more uniform particle dispersion include the use of dispersing agents. A liquid dispersant can be used to disperse small, inorganic, particles in an organic medium. Multiple types of liquid dispersants are used including non-surface-active polymers and surface-active substances. These materials can be added into the filled resin suspension in order to avoid the formation of clusters of particles. This improves the separation of particles in order to avoid cluster formation, sedimentation, and increases in viscosity. Surfactants can also be used as a dispersant. Surfactants are substances that can lower the surface tension between two phases of matter. Most of the time, these are amphiphilic organic compounds. Meaning that these substances contain both hydrophilic and hydrophobic regions in the same molecule. Therefore, they contain both water soluble, polar, and water insoluble, non-polar, regions. The use of dispersants and surfactants are known to be able increase the dispersion and decrease the viscosity of a highly filled resin for a given weight of filler.

Additionally, it is known that particle size and geometry play an important role in the distribution and suspension of fillers in a liquid resin. For a given weight of filler, the total surface area of the filler particles has a direct relationship with the viscosity of the filled resin. Therefore, a reduction in viscosity for a filled resin at a given weight can be achieved by using a larger filler particle size when compared to a smaller particle size. A broad distribution of particles sizes and geometries on the micron and nanometer scale have shown to be an efficient way to suspend solid particles in photopolymer resins. An example of this is shown in FIG. 5. The wide distribution allows for smaller particles to fill in the gaps between the larger particles when mixed into the liquid resin. This results in an increase in flowability, which keeps the viscosity of the resin low even when more filler is added.

One major drawback of the current state-of-art is that the viscosities of highly filled resins in the field are still at 1,000-2,500+ cP with ≤45-55% filler by weight with respect to the weight of the total resin even with the current chemical and mechanical methods applied. Another major drawback of the current state of the art is that some highly filled resins are thixotropic resins, i.e., where the resin's viscosity is much higher while standing and only decreases when it is actively being stirred, arise from current methods of development. This is a problem for a wide range of applications that requires the resin to maintain a low viscosity throughout its entire use. Additional methods to control viscosity involve the use of solvents and aqueous materials. Solvents and aqueous materials naturally have a very low viscosity but can complicate formulations and uses of liquid resins as the flammability of solvents, the freeze-thaw stability of aqueous liquids, and the potential shrinkage of the final product must be considered.

It is desirable to develop a highly filled, low viscosity resin with Newtonian properties, i.e., a fluid with a viscosity that is independent of shear stress and shear rate and therefore will have a consistent viscosity throughout the process that does not make use of added solvents or aqueous materials (e.g., not added in substantial amounts or the like) to facilitate solid particle dispersion.

Citation or identification of any document in this application is not an admission that such a document is available as prior art to the present invention.

### SUMMARY

In an aspect, the present invention provides highly dispersed, highly filled, low viscosity compositions. In an example embodiment, a highly dispersed, highly filled, low viscosity liquid composition comprises: a non-polar organic carrier fluid; a plurality of nano- and micro-sized inorganic particles; and multiple dispersants, at least a portion of which exhibit different association affinities for inorganic particles of a particular size or size range, and wherein the composition is substantially or completely free of water or other solvents and diluents.

A composition can exhibit various viscosity values and viscosity ranges. In an example embodiment, the composition comprises between at least about 30 weight % (wt. %) to about 90 wt. % of the plurality of inorganic particles based on the total weight of the composition and a viscosity of from about 200 centipoise (cP) to about 1000 cP at 250° C. In an example embodiment, the viscosity of the composition is from about 300 cp to about 500 cp at 25° C.

A composition can comprise particles of various sizes and size ranges. In an example embodiment, the composition comprises a weight ratio of the micro-sized inorganic particles to the nano-sized inorganic particles of from at least about 1/1 to at least about 10/1, from at least about 1/1 to at least about 6/1, or from at least about 1/1 to at least about 2.5/1. In an example embodiment, the micro-sized inorganic particles comprise an average particle size of from about 0.1 micron (μm) to about 100 μm, from about 0.25 μm to about 75 μm, from about 0.5 μm to about 50 μm, from about 0.75 μm to about 25 μm, from about 1 μm to about 10 μm, or from about 1 μm to about 20 μm; and the nano-sized inorganic particles comprise an average particle size of from about 0.1 nanometers (mm) to about 150 nm, from about 0.25 nm to about 100 nm, from about 0.5 nm to about 50 nm, from about 0.75 nm to about 40 nm, from about 1 nm to about 30 nm, or from about 10 nm to about 40 nm.

A composition can comprise various types of particles. In an example embodiment, the plurality of nano- and micro-sized inorganic particles comprise a substantially spherical geometric shape and at least at least a portion of which are in crystalline form. In an example embodiment, the nano-sized and the micro-sized inorganic particles independently comprise one or more ceramic(s) or precursor(s) thereof. In an example embodiment, the one or more ceramic(s) comprise, silicon dioxide, aluminum oxide, zirconium dioxide, or any combination thereof. In an example embodiment, the composition further comprises acrylate monomers. In an example embodiment, the nanoparticle- and the microparticle-sized inorganic particles independently comprise(s) one or more nonmetal oxide(s), one or more metal oxide(s), one or more flame retardant(s), one or more metal(s), or any combination thereof.

In an example embodiment, the nonmetal and/or metal oxide(s) is/are chosen from silicon dioxide, aluminum oxide, zirconium dioxide, and any combination thereof. In an example embodiment, the metal(s) is/are chosen from stainless steel, copper, aluminum, titanium, and any combination thereof. In an example embodiment, the flame retardant(s) is/are chosen from metal mono-, di-, and tri-hydroxide(s), metal organic phosphorus compound(s), and any combination thereof. In an example embodiment, the flame retardant(s) is/are chosen from aluminum trihydroxide, aluminum diethyl phosphinate, melamine zinc polyphosphate, and any combination thereof.

A composition can comprise a variety of dispersant(s). In an example embodiment, at least one dispersant has a higher association affinity for nanoparticle-sized inorganic particles and at least one dispersant has a higher association affinity for microparticle-sized inorganic particles. In an example embodiment, the at least one dispersant having a higher association affinity for nanoparticle-sized inorganic particles, and the at least one dispersant having a higher association affinity for microparticle-sized inorganic particles each individually comprise: a polar group selected based on the association affinity for the nanoparticle- or microparticle-sized inorganic particle; a nonpolar group selected for miscibility with the organic carrier fluid; and a linking group connecting the polar group and the nonpolar group. In an example embodiment, the length of each dispersant is selected, at least in part, to increase steric hindrance between the inorganic particles. In an example embodiment, the polar group(s) is/are independently chosen from alkoxysilane, poly(alkylene glycol), and phosphate ester polar group(s), wherein the nonpolar group(s)) is/are independently chosen from alkyl and vinyl nonpolar group(s), and/or wherein the linking group of the dispersant(s) and/or the surfactant(s) is/are independently chosen from aryl ether and alkyl ester linking group(s). In an example embodiment, at least one dispersant is selected to stabilize electrostatic and/or steric repulsion of the inorganic particles and/or other dispersants, optionally a phosphodiester polymer. In an example embodiment, the composition further comprises one or more surfactants. In an example embodiment, the composition comprises a weight ratio of the inorganic particles to the dispersant(s) of from about 1/1 to about 10/1, from about 2/1 to about 8/1, or from about 4/1 to about 6/1.

A composition can comprise a variety of carrier fluid(s). In an example embodiment, wherein the carrier fluid comprises one or more organic monomer(s), one or more organic oligomer(s), or any combination thereof. In an example embodiment, the composition is photocurable and further comprises one or more photo-initiators. In an example embodiment, a composition the composition further comprises one or more photo-stabilizers. In an example embodiment, the composition is thermocurable and comprises one or more thermal initiators. In an example embodiment, the composition further comprises one or more defoamer(s). In an example embodiment, the composition further comprises one or more pigments or coloring agent.

In an example embodiment, a composition comprises: a) a non-polar organic carrier fluid comprising curable organic monomers, curable organic oligomers, or combinations thereof; b) a plurality of nanoparticle- and microparticle-sized inorganic particles comprising between at least 30 wt. % to about 90 wt. % based on the total weight of the composition; and c) multiple dispersants comprising a methylacrylated silane, a polyethylene glycol and a phosphodiester polymer; and wherein the composition has a viscosity from about 200 cP to about 1000 cP at 250 C and is substantially or completely free of water or other solvents and diluents. In an example embodiment, the non-polar organic carrier comprises CFTA, HDDA, or a combination thereof. In an example embodiment, the plurality of inorganic particles comprise ceramics or precursors thereof and further comprising an acrylic monomer. In an example embodiment, the ceramic precursors comprise silicon dioxide, aluminum oxide, zirconium dioxide, and any combination thereof. In an example embodiment, the plurality of inorganic particles comprises one or more nonmetal oxide(s), one or more metal oxide(s), one or more flame retardant(s), one or more metal(s), or any combination thereof. In an example embodiment, the nanoparticle sized inorganic particles are fumed silicone dioxide and wherein the microparticle-sized inorganic particles are fused silicon dioxide in crystalline form and having a spherical geometric shape, optionally 2-6 mm in diameter. In an example embodiment, the composition comprises a weight ratio of the phosphodiester polymer to a poly(ethylene glycol) of from at least about 1/1 to at least about 10/1, from at least about 1/1 to at least about 6/1, or from at least about 1/1 to at least about 2.5/1; and/or at least 60 wt. % to at least 95 wt. % of methacrylated silane based on the total weight of the dispersant.

In an aspect, the present invention provides methods of making objects comprising highly dispersed, highly filled, low viscosity compositions of the present invention. In an example embodiment, a method of making an object comprises: forming one or more layer(s) comprising one or more compositions(s) of the present invention; optionally mixing, dispersing, and/or milling the composition(s) prior to and/or during the forming of one or more or all of the layer(s); solidifying the layer(s); and optionally, sintering the solidified layer(s), wherein an object is formed. In an example embodiment, the forming the layer(s) comprises coating or printing the composition(s) in the form of one layer and, optionally, repeating the coating or the printing the composition(s) to form multiple layers. In an example embodiment, the step of forming the one or more layer(s) comprises vat polymerization three-dimensional (3D) printing. In an example embodiment, the solidifying the layer(s) comprises thermal curing or ultra-violet (UV) radiation curing of the layer(s). In an example embodiment, the object comprises inorganic-polymer composite(s), metal-polymer composite(s), flame retardant-polymer composite(s), ceramic(s), metal(s), or any combination thereof.

In an aspect, the present invention provides objects comprising one or more composition(s) of the present invention and/or wherein the object is prepared by the method of the present invention. In an example embodiment, the object is in the form of a coating, a sheet, a film, a fiber, a textile, a solid article, a hollow article, a foam, or a composite. In an example embodiment, the object is a consumer product, an industrial product, a medical product or device, an architectural part, an automotive part, an aviation part, a construction part, or an electronics part.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present invention will be obtained by reference to the following detailed description that sets forth illustrative embodiments, in which the principles of the invention may be utilized, and the accompanying drawings of which:

FIG. 1—Colloidal chemistry.

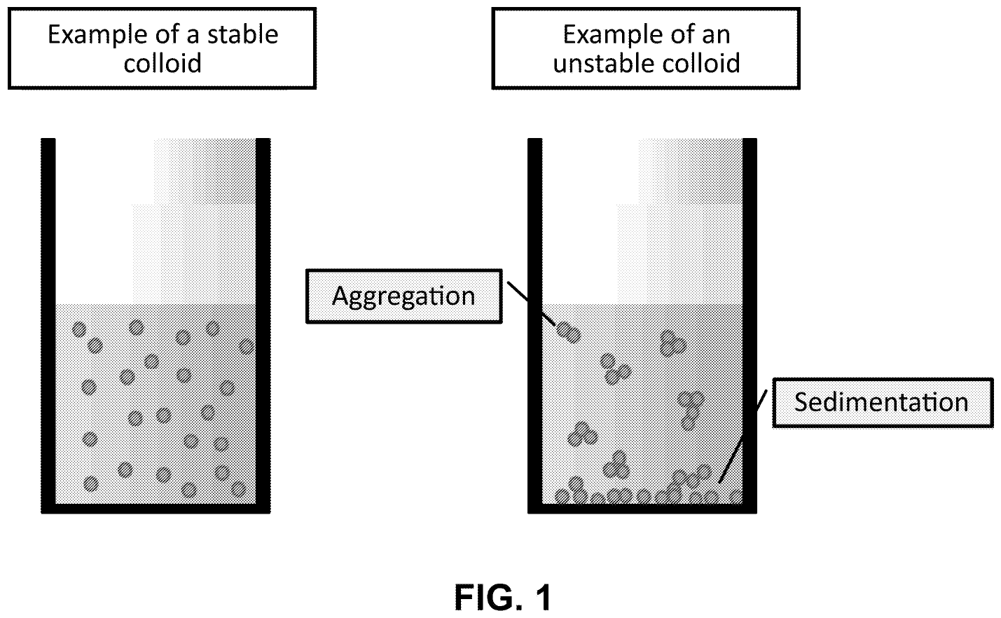

FIG. 2—Different types of dispersants and surfactants reacting to surfaces of different particle sizes in resin.

FIG. 3—(FIG. 3A) General schematic and (FIG. 3B) chemical structure of dispersant 2-[4-(2,4,4-trimethylpentan-2-yl)phenoxy]ethanol.

FIG. 4—(FIG. 4A) General schematic and (FIG. 4B) chemical structure of dispersant 3-methacryloxypropyltrimethoxysilane.

FIG. 5—Schematic of the effect of particle size distribution on flowability.

The figures herein are for illustrative purposes only and are not necessarily drawn to scale.

### DETAILED DESCRIPTION OF THE EXAMPLE EMBODIMENTS

### General Definitions

As used herein, the singular forms “a” “an”, and “the” include both singular and plural referents unless the context clearly dictates otherwise.

The term “optional” or “optionally” means that the subsequent described event, circumstance or substituent may or may not occur, and that the description includes instances where the event or circumstance occurs and instances where it does not.

The recitation of numerical ranges by endpoints includes all numbers and fractions subsumed within the respective ranges, as well as the recited endpoints.

The terms “about” or “approximately” as used herein when referring to a measurable value such as a parameter, an amount, a temporal duration, and the like, are meant to encompass variations of and from the specified value, such as variations of +/−10% or less, +/−5% or less, +/−1% or less, and +/−0.1% or less of and from the specified value, insofar such variations are appropriate to perform in the disclosed invention. It is to be understood that the value to which the modifier “about” or “approximately” refers is itself also specifically, and preferably, disclosed.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present invention. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention. For example, in the appended claims, any of the claimed embodiments can be used in any combination.

### Overview

In one aspect, embodiments disclosed herein provide highly dispersed, highly filled, low viscosity liquid compositions and uses thereof. In an aspect, highly dispersed, highly filled, low viscosity liquid composition of the present invention exhibits improved colloidal chemistry over current highly filled compositions, addressing the challenges thereof. In an example embodiment, highly dispersed, highly filled, low viscosity liquid compositions of the present invention are highly filled liquid resins having a low, constant viscosity at room temperature which improves manufacturing capabilities and ease of processing, and allows a higher percentage of solid particles to be mixed into the resins. In an example embodiment, highly dispersed, highly filled, low viscosity liquid compositions of the present invention have the traditional material properties and benefits found in highly filled systems but achieved at a lower viscosity. In an example embodiment, the low viscosity improves the speed and efficiency of the flow of the compositions, which provides solutions to applications requiring compositions with high flowability, e.g., 3D printing of liquid photocurable resins. In various example embodiments, the lower viscosity of highly dispersed, highly filled, low viscosity liquid compositions of the present invention is achieved by maximizing the degree of dispersion, stabilizing the suspension, and increasing the uniformity, or homogeneousness, of particles in one or more fluid(s). In various example embodiments, the present invention provides highly dispersed, highly filled, low viscosity liquid compositions by utilizing three factors: the type, geometry, size, and size distribution of the particles, the fluid(s) (e.g., organic systems) used as particle carrier(s), and the dispersants (e.g., surfactants) used to disperse the particles. In an example embodiment, the composition comprises less than 5.0% by weight of water or other solvents and diluents. In an example embodiment, the composition comprises less than 3.0% by weight of water or other solvents and diluents. In an example embodiment, the composition comprises less than 1.0% by weight of water or other solvents and diluents. An example composition is considered to be substantially or completely free of water or other solvents and diluents if it comprises less than 1.0% by weight of water or other solvents and diluents (e.g., less than 0.1%, less than 0.01%, or less than 0.005%).

In another aspect, embodiments disclosed herein provide methods of making an object comprising forming one or more layers comprising one or more of the compositions disclosed herein and solidifying. The method may optionally comprise mixing, dispersing and/or milling the composition(s) prior to and/or during the forming of the one or more layers. The method may also optionally comprise sintering the solidified layer(s) to form a final object. In one example embodiment, the step of forming the one or more layers comprises stereolithography, also referred to herein as 3D printing. The layers may be added in a “top-down” or “bottom-down” method. Top-down methods involve exposing a pool of the composition(s) to a light source from above, then, once a layer of composition is cured, moving the cured layer deeper into the pool of the composition(s) away from the light to allow uncured resin to flow over the cured region and become exposed to the light source. Bottom-up methods involving exposing a vat of composition(s) to a light source from below through a window at the bottom of the pool. The cured resin is then separated from the area of light exposure, or printing interface, and lifted out of the liquid vat allowing uncured composition to flow into the window to be cured.

In another aspect, embodiments disclosed herein comprise objects made from the compositions disclosed herein and/or made using the methods disclosed herein.

### Highly Dispersed, Highly Filled, Low Viscosity Compositions

In an aspect, the present invention provides highly dispersed, highly filled, low viscosity liquid compositions, including, but not limited to, curable liquid resin compositions or the like. In an example embodiment, a composition comprises a plurality of particles, one or more carrier fluid(s), and one or more dispersant(s). In an example embodiment, a composition is substantially or completely free of water or other solvents and diluents. In an example embodiment, a carrier fluid is a non-polar and/or organic carrier fluid. In an example embodiment, a plurality of particles comprises a plurality of inorganic particles. In an example embodiment, a plurality of particles comprises a plurality of nano-sized particles and micro-sized particles. In an example embodiment, a composition comprises multiple dispersants. In an example embodiment, at least a portion of dispersants have a similar association affinity for particles (e.g., inorganic particles) of a particular size or size range, such as, for example, nano-sized particles and micro-sized particles. In an example embodiment, at least a portion of dispersant(s) exhibit a different association affinity (e.g., an increased affinity, a decreased affinity, or the like) for particles (e.g., inorganic particles) of a particular size or size range, such as, for example, nano-sized particles or micro-sized particles. In an example embodiment, at least a portion of dispersant(s) have an increased affinity for nano-sized particles versus micro-sized particles and at least a portion of dispersants have an increased affinity for micro-sized particles versus nano-sized particles. Methods of measuring dispersant affinity are known in the art. In an example embodiment, dispersant affinity is determined (e.g. measured) using assessment of dispersion stability and viscosity of compositions comprising particular dispersants in combination with particular particles of a particular size or size distribution. Methods of measuring dispersion stability are known in the art. In an example embodiment, dispersion stability is determined (e.g., measured) by assessment of the rate of particle sedimentation. Methods of measuring viscosity are known in the art. In an example embodiment, viscosity is determined (e.g., measured) using a rotational viscometer, a capillary viscometer, a falling sphere viscometer, a falling ball viscometer, a falling piston viscometer, an oscillating piston viscometer, a vibrational viscometer, a bubble viscometer, a rectangular-slit viscometer, a Krebs viscometer, or the like.

In an example embodiment, a composition has a viscosity of from less than about 1000 cP at a temperature of about 250° C. In an example embodiment, a composition has a viscosity of from about 200 centipoise (cP) to about 1000 cP at about 25° C., including all 0.1 cP values and ranges therebetween (e.g., from about 250 cP to about 900 cP, from about 300 cP to about 500 cP, or from about 500 cP to about 900 cP, at about 25° C.). In an example embodiment, the composition exhibits at least substantially or completely Newtonian behavior or the like. As used herein, unless otherwise indicated, a fluid exhibits Newtonian behavior when the fluid has a constant viscosity at a given temperature (e.g., when the shear rate of the fluid is directly proportional to the shear stress of the fluid).

### Particles

A composition can comprise various quantities of particles. In an example embodiment, a composition comprises about 30 weight % (wt. %) or greater of a plurality of particles, based on the total weight of the composition. In an example embodiment, a composition comprises from about 30 wt. % to about 90 wt. % of a plurality of particles, including all 0.1 wt. % values and ranges therebetween, based on the total weight of the composition (e.g., from about 40 wt. % to about 90 wt. %, from about 50 wt. % to about 90 wt. %, from about 60 wt. % to about 90 wt. %, from about 70 wt. % to about 90 wt. %, or from about 80 wt. % to about 90 wt. %, from about 30 wt. % to about 80 wt. %, from about 30 wt. % to about 70 wt. %, from about 30 wt. % to about 60 wt. %, from about 30 wt. % to about 50 wt. %, from about 30 wt. % to about 40 wt. %, from about 40 wt. % to about 90 wt. %, from about 40 wt. % to about 70 wt. %, from about 40 wt. % to about 60 wt. %, from about 40 wt. % to about 50 wt. %, from about 50 wt. % to about 80 wt. %, from about 50 wt. % to about 70 wt. %, from about 50 wt. % to about 60 wt. %, from about 60 wt. % to about 80 wt. %, from about 60 wt. % to about 70 wt. %). In an example embodiment, a composition comprises a weight ratio of particles to dispersant(s) of about 1/1 or greater. In an example embodiment, a composition comprises a weight ratio of particles to dispersant(s) of from about 1/1 to about 10/1, including all integer weight ratio values and ranges therebetween (e.g., from about 1/1 to about 2.5/1, from about 1/1 to at least about 6/1, from about 2/1 to about 8/1, or from about 4/1 to about 6/1).

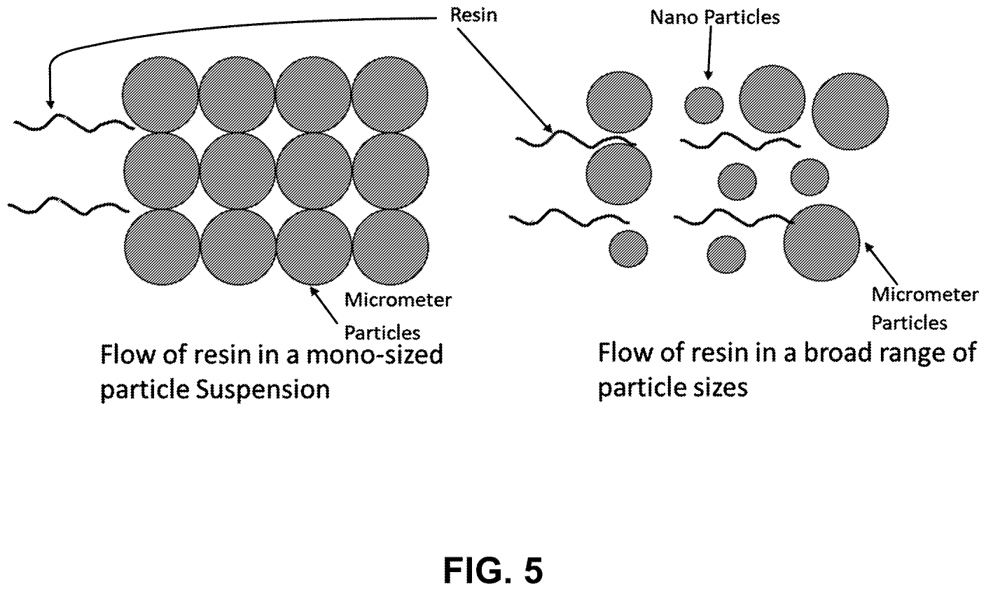

A composition can comprise particles of various sizes and size distributions. In an example embodiment, micron scale and nanometer scale particle sizes are used to efficiently suspend particles in organic liquids such as, for example, liquid resins. An example embodiment of such a particle size distribution is shown in FIG. 5. While not bound by a particular theory, a wide distribution of particle sizes on the micron and nanometer scale allows for smaller particles to fill in the gaps between larger particles when mixed into organic liquids such as, for example, liquid resins. In various example embodiments, this results in an increase in flowability, which keeps the viscosity of the liquid resin low even when more filler is added. However, since surface area increases with a decrease in particle size, the viscosity will increase as more smaller particles are added. Various combinations of micrometer sized and nanometer sized particles can be utilized at certain ratios as to maintain the consistent low viscosity of the slurry while effectively stabilizing particle suspension and uniformity. In an example embodiment, this combination of nanoscale and microscale particles provides material properties that are consistent with traditional filled resin systems.

In an example embodiment, micro-sized particle(s), on average, comprise a particle size (e.g., a longest linear dimension, such as, for example, a diameter or the like) of about 0.1 micron (μm) or greater. In an example embodiment, micro-sized particle(s), on average, comprise a particle size (e.g., a longest linear dimension, such as, for example, a diameter or the like) of from about 0.1 micron (μm) to about 100 μm, including all 0.01 μm values and ranges therebetween (e.g., from about 0.25 m to about 75 μm, from about 0.5 m to about 50 μm, from about 0.75 μm to about 25 μm, from about 1 μm to about 10 μm, or from about 1 μm to about 20 μm).

In an example embodiment, nano-sized particle(s), on average, comprise a particle size (e.g., a longest linear dimension, such as, for example, a diameter or the like) of about 150 nm or less. In an example embodiment, nano-sized particle(s), on average, comprise a particle size (e.g., a longest linear dimension, such as, for example a diameter or the like) of from about 0.1 nanometers (nm) to about 150 nm, including all 0.01 nm values and ranges therebetween (e.g., from about 0.25 nm to about 100 nm, from about 0.5 nm to about 50 nm, from about 0.75 nm to about 40 nm, from about 1 nm to about 30 nm, or from about 10 nm to about 40 nm).

In an example embodiment, a plurality of particles comprises a weight ratio of micro-sized particles to nano-sized particles of about 1:1 or greater. In an example embodiment, a plurality of particles comprises a weight ratio of micro-sized particles to nano-sized particles of from about 1:1 to at about 10:1, including all integer weight ratio values and ranges therebetween (e.g., from about 1:1 to about 6:1, or from about 1:1 to about 2.5:1). In various example embodiments, a plurality of particles comprises a weight ratio of micro-sized particles to nano-sized particles is about 4:3, about 5:2, or about 6:1.

A composition can comprise various types of particles. In an example embodiment, a plurality of particles comprise organic particles, inorganic particles, or the like, or any combination thereof. In an example embodiment, at least a portion of, substantially all of, or all of a plurality of particles are at least partially, substantially, or completely inorganic. In an example embodiment, a plurality of particles independently comprise one or more ceramic(s) or one or more precursor(s) thereof, one or more nonmetal oxide(s), one or more metal oxide(s), one or more flame retardant(s), one or more metal(s), or the like, or any combination thereof.

In one example embodiment, ceramics or precursors thereof may comprise acrylate monomers. In an example embodiment, ceramics or precursors thereof may also comprise(s) oxide(s), carbide(s), nitride(s), sulfide(s), fluoride(s), boride(s), silicate(s), glass(es) or the like, or any combination thereof. In an example embodiment, ceramic(s) comprise nonmetal(s) (e.g., silicon or the like), metal(s) (e.g., aluminum, zirconium, titanium, uranium, and the like), or the like, or any combination thereof. In an example embodiment, ceramic(s) comprise nonmetal oxide(s), metal oxide(s), or the like, or any combination thereof.

In an example embodiment, nonmetal oxide(s) is/are chosen from silicon oxides (e.g., silicon dioxide (SiO₂) or the like) and the like. In an example embodiment, nonmetal oxide(s) comprise(s) fused silicon dioxide microparticle(s) in combination with fumed silicone dioxide nanoparticle(s). In an example embodiment, fused silicon dioxide microparticle(s) is/are in crystalline form and has/have a spherical geometric shape. In an example embodiment, fused silica microparticle(s), on average, have a particle size of from about 2 micrometers (μm) to about 6 μm in diameter, including all 0.1 m values and ranges therebetween. In an example embodiment, fused silicon dioxide microparticle(s) is/are used in combination with fumed silica nanoparticle(s) to create compositions of the present disclosure (e.g., liquid photopolymer resins or the like). In an example embodiment, metal oxide(s) is/are chosen from aluminum oxides (e.g., aluminum oxide (Al₂O₃) or the like), zirconium oxides (e.g., zirconium dioxide (ZrO₂) or the like), and the like, and any combination thereof. In an example embodiment, metal(s) is/are chosen from stainless steel metal, copper metal, aluminum metal, titanium metal, and the like, and any combination thereof. In an example embodiment, flame retardant(s) is/are chosen from metal mono-, di-, and tri-hydroxide(s) (e.g., aluminum trihydroxide or the like), metal organic phosphorus compound(s) (e.g., aluminum diethyl phosphinate, melamine zinc polyphosphate, or the like), and the like, and any combination thereof. In an example embodiment, flame retardant(s) has/have a particle size of, on average, from about 0.25 μm to about 30 m, including all 0.1 m values and ranges therebetween.

A highly dispersed, highly filled, low viscosity liquid composition can comprise various particle morphologies, geometries, sizes and/or size distributions. In an example embodiment, at least a portion of the microparticle(s) and/or the nanoparticle(s) comprise(s) a substantially spherical geometric shape or the like. In an example embodiment, at least a portion of the microparticle(s) and/or the nanoparticle(s) are in crystalline form and/or in amorphous form. In an example embodiment, the microparticle(s) and/or the nanoparticle(s) are substantially spherical geometric shape, at least a portion of which are in crystalline form. In an example embodiment, microparticle(s) comprise fused silicon dioxide microparticle(s) in crystalline form and having a spherical geometric shape.

### Dispersants

A highly dispersed, highly filled, low viscosity liquid composition can comprise various dispersant compositions. As used herein, unless otherwise indicated, dispersant(s) is/are used to disperse particles in carrier fluid(s). In an example embodiment, a dispersant is a liquid dispersant. Multiple types of dispersants can be used: non-surface-active polymers, surface-active substances, or the like, or any combination thereof. In an example embodiment, these materials are added into the filled fluid suspension in order to avoid the formation of clusters of the particles. In an example embodiment, dispersant(s) improve(s) the separation of the particles in order to avoid cluster formation, sedimentation, and increases in viscosity.

In an example embodiment, surfactant(s) are also used as dispersant(s). As used herein, unless otherwise indicated, “surfactants” are substances that can lower the surface tension between two phases of matter. Generally, these are amphiphilic organic compounds, meaning that these substances contain both hydrophilic and hydrophobic regions in the same molecule. Therefore, they contain both water soluble, polar, and water insoluble, non-polar, regions. In an example embodiment, a surfactant acts as a dispersant to lower the surface tension of the solid and liquid phases and to evenly disperse the particles. This allows for the particles to be miscible with fluid(s) (e.g., organic liquids, such as, for example, resins or the like) with which they otherwise would not be miscible in the absence of the surfactants acting as dispersants. As used herein, unless otherwise indicated, the term “dispersant” or “dispersants” includes dispersants, surfactants acting as dispersants, or any combination thereof.

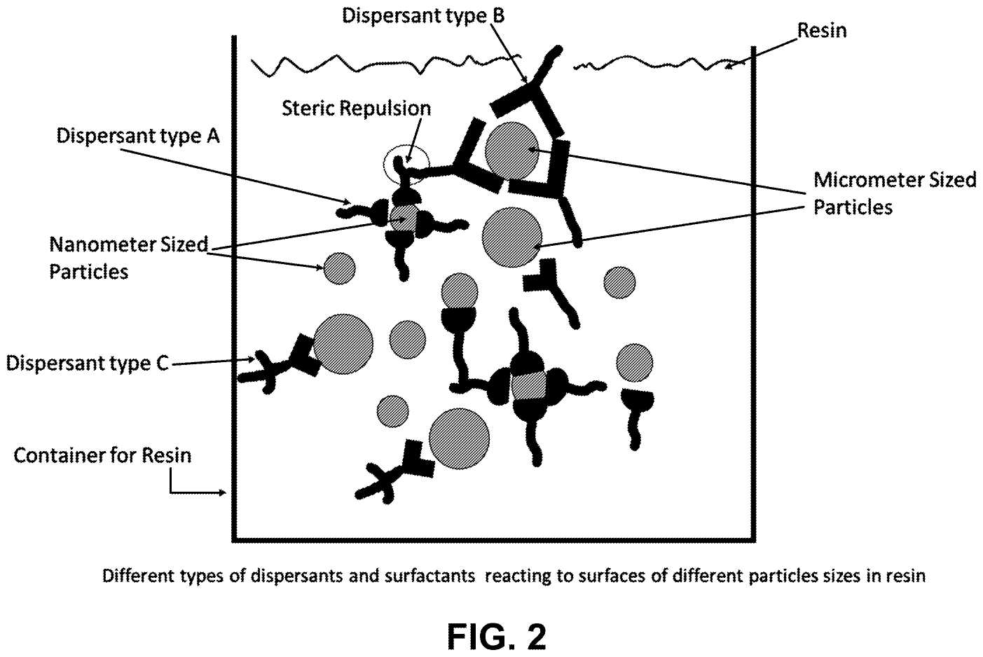

In an example embodiment, a dispersant is chosen specifically for the different sizes of the particles used to fill the organic liquid. In an example embodiment, the same dispersant (e.g., a dispersant having an association affinity for all particle sizes or size ranges, is used. In an example embodiment, each particle size is targeted with a preferred dispersant (e.g. a dispersant having a high affinity for the targeted particle size). Through experimentation, it can be determined which dispersants facilitate the highest level of dispersion for a given particle at a given size. The individual dispersants selected for use in this invention have a high affinity for one size of filler particle and a low affinity for another size of filler particle used. For example, one dispersant is chosen due to its high affinity for the micro-sized particles used in the highly filled resin, and another dispersant is chosen due to its high affinity for the nano-sized particles of the highly filled resin. In an example embodiment, at least three dispersants are used, the dispersants comprising: at least one dispersant with a high affinity for nano-sized particles, at least one dispersant with a high affinity for micro-sized particles, and at least one dispersant having a high affinity for each of nano-sized and micro-sized particles. Additional dispersants or surfactants can be used in order to further facilitate dispersion of the particles and further decrease the surface tension of the liquid resin. This approach involving combining the use of multiple particle sizes and multiple dispersants and surfactants in a highly filled resin is a novel way to ensure dispersion and stability of suspended particles. A schematic of this example embodiment is shown in FIG. 2.

In an example embodiment, dispersant(s) is/are chosen based on the polarity and miscibility of the components needed to be mixed. Part of each dispersant molecule can be miscible with one component of the formulation and the other part of the dispersant molecule can be compatible another component of the formulation. In an example embodiment, dispersant(s) comprise(s): a polar group; a nonpolar group; and a linking group connecting the polar group and the nonpolar group. In an example embodiment, a polar group is selected based on the association affinity for the nano-sized or micro-sized particle and the nonpolar group is selected for miscibility with the organic carrier fluid. In an example embodiment, a length of each dispersant is selected, at least in part, to increase steric hindrance between particles (e.g. inorganic particles or the like).

In an example embodiment, each dispersant molecule is chosen for dispersing a particular type of particle (e.g., a particular type of inorganic particle or the like) (e.g., ceramic particles, flame retardant particles, metal particles, or the like, or any combination thereof) and comprises a combination of hydrophilic, non-polar chains, and hydrophobic, or polar chains. In an example embodiment, a fluid used to disperse inorganic particles. In an example embodiment, a carrier fluid used to disperse ceramic particles (e.g., silica particles) is an organic liquid resin which tends to be less polar than such ceramic particles, for example. In an example embodiment, hydrophilic ends of a dispersant are able to attach or react to the surface of ceramic particles (e.g., silica particles or the like) while the hydrophobic end is miscible with a carrier fluid (e.g., an organic, monomer/oligomeric resin). In an example embodiment, this choice of dispersant or surfactant molecule creates a stable suspension in the completely mixed resin. In an example embodiment, a length of each dispersant or surfactant molecule creates a steric hinderance between the particles (e.g., silica particles or the like), preventing them from conglomerating, while the chemistry of the dispersants and surfactants lowers the surface tension of the resin to allow a high miscibility of the particles in the resin. Therefore, in this example, a length of each dispersant and surfactant molecules is a factor in material selection, not just the chemistry. A methacrylated silane, for example, contains both a silicone chain and an acrylic chain. Since, in this example embodiment, a resin comprising ceramic particles contains both acrylic monomers and inorganic particles, methacrylated silane can be used as a surfactant and a dispersant for ceramic particles. In this example, methacrylated silane acts as a surfactant to lower the surface tension, allowing for inorganic particles to be miscible in resin but also to be suspended in a uniform dispersion due to the phenomenon previously mentioned.

In an example embodiment, polar group(s) is/are independently chosen from alkoxysilane, poly(alkylene glycol), and phosphate ester polar group(s). In an example embodiment, nonpolar group(s) is/are independently chosen from alkyl and vinyl nonpolar group(s). In an example embodiment, linking group(s) is/are independently chosen from aryl ether and alkyl ester linking group(s). In an example embodiment, polar and/or nonpolar group(s) is/are selected to stabilize electrostatic and/or steric repulsion of particles (e.g., inorganic particles) and/or other dispersants, optionally a phosphodiester polymer.

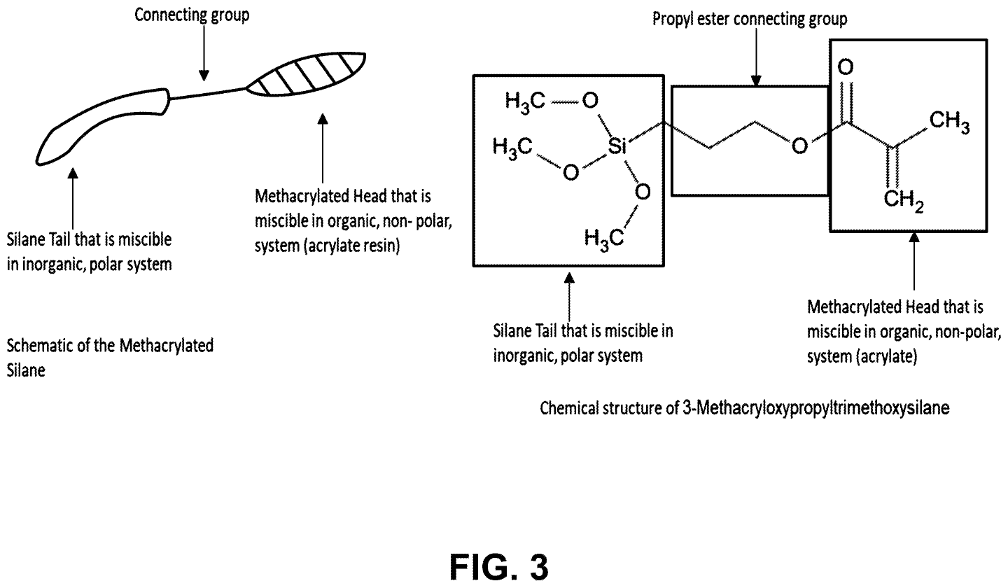

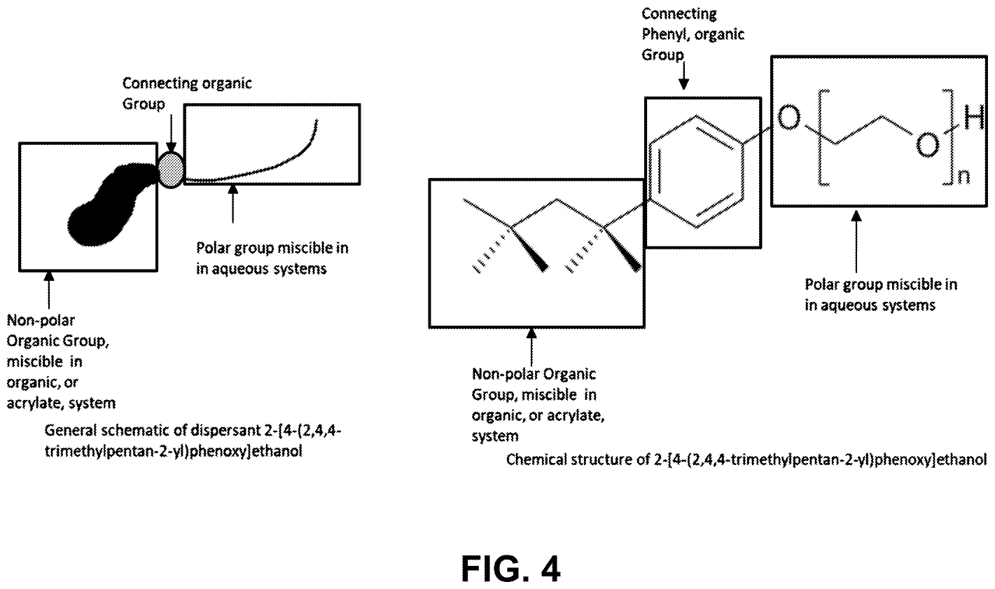

In an example embodiment, a combination of at least two dispersants is used, the combination comprising: at least one dispersant comprising a poly(alkylene glycol) or the like (e.g., a surfactant comprising a poly(ethylene glycol) (PEG) or the like (e.g., a PEG alkyl ether, PEG aryl ether, PEG alkylaryl ether, or the like, including, but not limited to the representative example shown in FIG. 3)), and at least one dispersant comprising a phosphate ester or the like (e.g., a dispersant comprising a phosphodiester polymer or the like). In an example embodiment, a combination of at least two dispersants is used, the combination comprising: at least one dispersant comprising a poly(alkylene glycol) or the like (e.g., a surfactant comprising a poly(ethylene glycol) or the like (e.g., an alkylaryl ethoxylate, including, but not limited to the representative example shown in FIG. 3)), at least one dispersant comprising a vinyl functional silane (e.g., a surfactant comprising an organofunctional silane or the like, such as, for example, an acrylated silane, a methacrylated silane, or the like, including, but not limited to the representative example shown in FIG. 4).

In an example embodiment, a combination of three dispersants is used, the combination comprising: at least one dispersant comprising a poly(alkylene glycol) or the like (e.g., a surfactant comprising a PEG or the like (e.g., a PEG alkyl ether, a PEG aryl ether, a PEG alkylaryl ethoxylate, or the like, including, but not limited to the representative example shown in FIG. 3)), and at least one dispersant comprising a phosphate ester or the like (e.g., a dispersant comprising a phosphodiester polymer or the like), and at least one dispersant comprising a vinyl functional silane (e.g., a surfactant comprising an organofunctional silane or the like, such as, for example, an acrylated silane, a methacrylated silane, or the like, including, but not limited to the representative example shown in FIG. 4).

In an example embodiment, a dispersant comprising a poly(alkylene glycol) or the like (e.g., a surfactant comprising a PEG or the like (e.g., a PEG alkyl ether, a PEG aryl ether, a PEG alkylaryl ethoxylate, or the like, including, but not limited to the representative example shown in FIG. 3)) can work in conjunction with a dispersant comprising a phosphoester group (e.g., a phosphodiester polymer) to assure stability of electrostatic and steric repulsions between solid particles in an organic liquid. In an example embodiment, a composition comprises an equal or greater weight percent (wt. %) of dispersant(s) comprising a phosphoester group (e.g., a phosphodiester polymer) as compared to dispersant(s) comprising a poly(ethylene glycol). In an example embodiment, a composition comprises: a weight ratio of dispersant(s) comprising a phosphoester group (e.g., a phosphodiester polymer) to dispersant(s) comprising a poly(alkylene glycol) or the like (e.g., a surfactant comprising a PEG or the like (e.g., a PEG alkyl ether, a PEG aryl ether, a PEG alkylaryl ethoxylate, or the like, including, but not limited to the representative example shown in FIG. 3)) of from at least about 1:1 to at least about 10:1, including all integer weight ratio values and ranges therebetween (e.g., from at least about 1:1 to at least about 8:1, from at least about 1:1 to at least about 6:1, from at least about 1:1 to at least about 4:1, or from at least about 1:1 to at least about 2.5:1, or about 1:1, about 2:1, or about 3:2).

In various examples, a vinyl functional silane (e.g., an acrylated silane, a methacrylated silane, and the like, and any combination thereof) comprises a polar, hydrophilic silicone “head” and a non-polar, hydrophobic vinyl “tail”. A polar head can attach itself to the surface of particles to efficiently mix and disperse it into a carrier fluid while lowering the surface tension between particles and a carrier fluid. In various example embodiments, these combinations were found to effectively disperse inorganic particles in non-polar organic media. In an example embodiment, these combinations at these ratios were found to maintain a low viscosity and a stable suspension of inorganic particles in an organic liquid, such as, for example, a resin or the like, even at high levels of particles. In various example embodiments, these improvements in the degree of dispersion, decrease the viscosity of the slurry while increasing the amount of filler that can be added. These combinations at these ratios can also allow for a homogeneous suspension and mixture. These dispersants in combination are a novel way to develop a highly filled, low viscosity liquid resin.

In an example embodiment, dispersant(s) comprise(s) at least 60 weight percent (wt. %), including all 0.1 wt. % values and ranges therebetween, of a vinyl functional silane (e.g., an acrylated silane, a methacrylated silane, and the like, and any combination thereof), based on the total weight of dispersant(s) (e.g., at least 65 wt. %, at least 70 wt. %, at least 75 wt. %, at least 80 wt. % at least 90 wt. %, or at least 95 wt. %).

In an example embodiment, a composition comprises an equal or greater weight percent (wt. %) of particles as compared to dispersant(s). In an example embodiment, a composition comprises a weight ratio of particles to dispersant(s) of about 1:1 or greater. In various examples, a composition comprises a weight ratio of particles to dispersant(s) of from about 1:1 to about 10:1, including all integer weight ratio values and ranges therebetween (e.g., from about 2:1 to about. 8:1, or from about 4:1 to about 6:1).

### Carrier Fluids

A highly dispersed, highly filled, low viscosity liquid composition can comprise various types of carrier fluid(s). In an example embodiment, a composition comprises curable carrier fluid(s) (e.g., monomer(s), oligomer(s), or the like, or any combination thereof) or the like. In an example embodiment, a composition is a curable liquid resin composition, and carrier fluid(s) comprise(s) curable liquid resin(s) or the like. As used herein, unless otherwise indicated, the term “curable” or “curing” or “cured” refers to polymerization, crosslinking, or the like, or any combination thereof. As used herein, the term “curable liquid resin” refers to any liquid resin which can be hardened into a solid by curing or the like.

A composition can comprise various curable carrier fluid(s) (e.g., curable liquid resin(s)). In an example embodiment, curable carrier fluid(s) (e.g., curable liquid resin(s)) comprise(s) one or more monomer(s), one or more oligomer(s), or the like, or any combination thereof. In an example embodiment, monomer(s) and/or oligomer(s) is/are polar or nonpolar, organic or inorganic, saturated or unsaturated, mono-functional or multifunctional, or the like, or any combination thereof.

In an example embodiment, monomer(s) and/or oligomer(s) is/are vinyl functional monomer(s) and/or oligomer(s). In an example embodiment, vinyl functional monomer(s) and/or oligomer(s) is/are chosen from acrylate monomer(s) and/or oligomer(s), methacrylate monomer(s) and/or oligomer(s), vinyl functional silicone (e.g., vinylalkoxysiloxane and the like) monomer(s) and/or oligomer(s), and the like, and any combination thereof. In an example embodiment, vinyl functional monomer(s) and/or oligomer(s) is/are chosen from cyclic trimethylolpropane formal acrylate (CTFA) monomer(s) and/or oligomer(s), 1,6-hexanediol diacrylate (HDDA) monomer(s) and/or oligomer(s), vinylmethoxysiloxane monomer(s) and/or oligomer(s), or the like, or any combination thereof. In an example embodiment, a composition comprises acrylate monomer(s) and/or oligomer(s) and a plurality of particles comprising ceramic(s), such as, for example, silicon dioxide, aluminum oxide, zirconium dioxide, or any combination thereof.

In an example embodiment, a composition is a photocurable composition. In an example embodiment, a photocurable composition further comprises one or more photoinitiators, photostabilizers, or the like, or any combination thereof. In an example embodiment, a photocurable composition is an ultraviolet (UV) radiation-curable composition or the like, and comprises one or more UV initiator(s), UV inhibitor(s), or the like, or any combination thereof. In an example embodiment, UV initiator(s) is/are chosen from phosphinate(s), phosphine oxide(s), and the like, and any combination thereof. In an example embodiment, UV inhibitor(s) is/are chosen from polycyclic aromatic hydrocarbon(s) and the like.

In an example embodiment, a curable composition is a thermocurable composition. In an example embodiment, a thermocurable composition further comprises one or more thermal initiator(s), thermal inhibitor(s), or the like, or any combination thereof. In an example embodiment, thermal initiator(s) is/are chosen from thermal free radical initiator(s) and the like, such as, for examples, peroxide(s) and the like.

In an example embodiment, carrier fluid(s) has/have a viscosity of from about 5 cP to about 300 cP at a temperature of about 25° C., including all 0.1 cP values and ranges therebetween (e.g., about 300 cP or less, about 200 cP or less, about 100 cP or less, about 50 cP or less, about 25 cP or less, or about 10 cP or less, or from about 5 cP to about 200 cP, from about 5 cP to about 100 cP, or from about 5 cP to about 80 cP, at about 25° C.). In an example embodiment, carrier fluid(s) comprising only monomer(s) has/have a viscosity of from about 5 cP to about 100 cP at about 25° C., including all 0.1 cP values and ranges therebetween (e.g., from about 5 cP to about 80 cP, from about 5 cP to about 50 cP, from about 5 cP to about 20 cP, or from about 5 cP to about 15 cP at about 25° C.). In various examples, carrier fluid(s) comprising only oligomer(s) has/have a viscosity of from about 100 cP to about 20,000 cP at about 25° C., including all 0.1 cP values and ranges therebetween. In various examples, carrier fluid(s) comprising monomer(s) and oligomer(s) has/have a viscosity of from about 20 cP to about 300 cP at about 25° C., including all 0.1 cP values and ranges therebetween (e.g., from about or 30 cP to about 150 cP, or from about 40 cP to about 100 cP at about 25° C.).

In an example embodiment, a composition comprising ceramic(s) further comprise carrier fluid(s) comprising acrylate monomer(s) and having a starting viscosity of from about 5 cP to about 80 cP at about 25° C., including all 0.1 cP values and ranges therebetween. In an example embodiment, a composition comprising flame retardant(s) further comprises carrier fluid(s) comprising a combination of monomer(s), and oligomer(s) and having a starting viscosity of from about 40 cP to about 150 cP at about 25° C., including all 0.1 cP values and ranges therebetween.

Due to additional features that are described below, in an example embodiment, diluents, water, and organic solvents are not needed in order to lower the viscosity of a composition. In an example embodiment, a composition is at least substantially or completely free of water, solvent, or the like, or any combination thereof.

### Additives

A highly dispersed, highly filled, low viscosity liquid composition can comprise various additives. In an example embodiment, a composition comprises one or more additives comprising one or more surfactants, one or more defoamer(s), one or more pigment(s) or other coloring agent(s), or the like, or any combination thereof. In an example embodiment, defoamer(s) is/are chosen from polymeric hydrocarbon defoamers, or the like, or any combination thereof. In an example embodiment, the defoamer comprises decene homopolymer hydrogenated or the like.

### Methods of Use of Highly Dispersed, Highly Filled, Low-Viscosity Liquid Compositions

The highly dispersed, highly filled, low viscosity liquid compositions of the present invention can be utilized in various applications including, but not limited to, chemical processing, microfluidics, colloidal fluids, 3D printing (e.g., vat polymerization 3D printing or the like), coatings, and other types of additive manufacturing. Furthermore, such applications can utilize highly filled low viscosity fluids comprising liquid resins (e.g., thermoset resins, UV curable resins, or the like, or any combination thereof), ceramics, metals, or the like, or any combination thereof.

For vat polymerization 3D printing, highly filled resins are desirable for many reasons. Highly filled materials provide unique material properties in manufactured products when compared to non-filled resins, such as high durability, high tensile strength, and flame retardance. In an example embodiment, highly filled, photopolymer resins make it possible to achieve these properties when printing a final product without having to be limited to standard manufacturing practices. In vat polymerization 3D printing, continuous printing is favored over layer-by-layer printing to achieve high printing speeds and quality products to compete with standard manufacturing practices. In order to achieve continuous printing, the liquid resin used must have a low enough viscosity to flow and replace cured resin at a rate that is not slower than the rate of the curing reaction. In an example embodiment, the low viscosity of the present invention allows for high-speed vat polymerization 3D printing that is continuous and not limited to layer-by-layer due to its flowability as previously described. Layer-by-layer 3D printing is a much slower process but is necessary for resins of high viscosities.

In the field of ceramics, liquid resins can be used to manufacture fully ceramic products or ceramic break-away molds. In an example embodiment, the present invention provides a way to create ceramic 3D printed parts. In an example embodiment, the highly filled resin is filled with particles such as silicon oxide or aluminum oxide, that are typically used in manufacturing of ceramics. A highly filled, low viscosity ceramic resin of the present disclosure can provide a way to quickly manufacture custom ceramic parts on a large scale.

### Methods of Making Objects Comprising Compositions of the Present Invention

In an aspect, the present invention provides methods of making objects comprising highly dispersed, highly filled, low viscosity compositions of the present invention. In an example embodiment, the present disclosure provides methods of making an object, the method comprising: forming one or more layer(s) comprising one or more highly dispersed, highly filled, low viscosity compositions(s) of the present invention; and solidifying the layer(s); wherein an object is formed. In an example embodiment, the method further comprises mixing, dispersing, and/or milling the composition(s) prior to and/or during the forming of one or more or all of the layer(s). In an example embodiment, the method further comprises sintering the solidified layer(s).

### Forming One or More Layer(s)

Methods of forming layers comprising highly filled compositions(s) is known in the art. Nonlimiting examples of methods of forming layers includes coating and printing. In an example embodiment, the forming the layer(s) comprises coating or printing of one or more composition(s) of the present invention in the form of one layer. In an example embodiment, the method further comprises repeating the coating or the printing of the composition(s) to form multiple layers.

In an example embodiment, the forming the layer(s) comprises printing of the composition(s). Nonlimiting examples of printing of highly filled compositions(s) include casted sampling and three-dimensional (3D) printing. In an example embodiment, the forming the layer(s) comprises vat polymerization 3D printing of the one or more compositions(s) of the present invention.

Mixing, Dispersing, and/or Milling the Composition(s)

Various mechanical processing methods can be used to increase the particle dispersion, increase the homogeneity, and/or reduce the viscosity of the composition(s) during mixing of the solid and liquid materials. Methods of mechanical processing of highly filled fluid composition(s) are known in the art. Nonlimiting examples of suitable mechanical processing methods include, but are not limited to, mixing, dispersing, milling, and the like.

### Solidifying the Layer(s)

Various methods of solidifying highly filled fluid composition(s) can be used to solidify the formed layer(s). Methods of solidifying fluid composition(s) are known in the art. Nonlimiting examples of suitable methods of solidifying fluid composition(s) include drying, and curing. In an example embodiment, the composition is a curable liquid resin composition, and the solidifying the layer(s) comprises thermal curing or ultra-violet (UV) radiation curing of the layer(s). In an example embodiment, the method forms and solidifies the layer(s) in a continuous process. In an example embodiment, the method forms and solidifies the layers in a discontinuous (e.g., layer-by-layer) process.

### Sintering the Solidified Layer(s)

Various methods of sintering highly filled solid composition(s) can be used to sinter the solidified layer(s). Methods of sintering highly filled solid composition(s) are known in the art. Nonlimiting examples of sintering highly filled solid composition(s) include liquid phase sintering.

### Formed Object

A formed object can comprise one or more highly dispersed, highly filled, low viscosity composition(s) of the present invention, one or more solidified derivatives thereof, one or more solidified and sintered derivative(s) thereof, or any combination thereof. A formed object can be prepared by a method of the present invention. In an example embodiment, a formed object is formed by 3D printing, curing, and optionally sintering of one or more composition(s) of the present invention.

Formed objects can comprise various chemical compositions. In an example embodiment, an object comprises one or more inorganic-polymer composite(s), one or more metal-polymer composite(s), one or more flame retardant-polymer composite(s), one or more ceramic(s), one or more metal(s), or any combination thereof. In an example embodiment, a formed object is in the form of a coating, a sheet, a film, a fiber, a textile, a solid article, a hollow article, a foam, or a composite. In an example embodiment, a formed object is a consumer product, an industrial product, a medical product or device, an architectural part, an automotive part, an aviation part, a construction part, or an electronics part.

The invention may be further understood with reference to the following set of numbered clauses:
1. A highly dispersed, highly filled, low viscosity liquid composition comprising a non-polar organic carrier fluid, a plurality of nano- and micro-sized inorganic particles, and multiple dispersants, at least a portion of which exhibit different association affinities for inorganic particles of a particular size or size range, and wherein the composition is substantially or completely free of water or other solvents and diluents.
2. The composition of clause 1, wherein the composition comprises between at least about 30 weight % (wt. %) to about 90 wt. % of the plurality of inorganic particles based on the total weight of the composition and a viscosity of from about 200 centipoise (cP) to about 1000 cP at 25o C.
3. The composition of clause 2, wherein the viscosity of the composition is from about 300 cp to about 500 cp at 25o C.
4. The composition of any one of the preceding clauses, wherein the composition comprises a weight ratio of the micro-sized inorganic particles to the nano-sized inorganic particles of from at least about 1/1 to at least about 10/1, from at least about 1/1 to at least about 6/1, or from at least about 1/1 to at least about 2.5/1.
5. The composition any one of the preceding clauses, wherein the plurality of nano- and micro-sized inorganic particles comprise a substantially spherical geometric shape and at least at least a portion of which are in crystalline form.
6. The composition of any one of the preceding clauses, wherein the micro-sized inorganic particles comprise an average particle size of from about 0.1 micron (mm) to about 100 mm, from about 0.25 mm to about 75 mm, from about 0.5 mm to about 50 mm, from about 0.75 mm to about 25 mm, from about 1 mm to about 10 mm, or from about 1 mm to about 20 mm; and the nano-sized inorganic particles comprise an average particle size of from about 0.1 nanometers (mm) to about 150 nm, from about 0.25 nm to about 100 nm, from about 0.5 nm to about 50 nm, from about 0.75 nm to about 40 nm, from about 1 nm to about 30 nm, or from about 10 nm to about 40 nm.
7. The composition of any one of the preceding clauses, wherein the nano-sized and the micro-sized inorganic particles independently comprise one or more ceramic(s) or precursor(s) thereof.
8. The composition of clause 7, wherein the one or more ceramic(s) comprise, silicon dioxide, aluminum oxide, zirconium dioxide, or any combination thereof
9. The composition of clause 7 or 8, further comprising acrylate monomers.
10. The composition of any one of the preceding clauses, wherein the nanoparticle- and the microparticle-sized inorganic particles independently comprise(s) one or more nonmetal oxide(s), one or more metal oxide(s), one or more flame retardant(s), one or more metal(s), or any combination thereof.
11. The composition of clause 10, wherein the nonmetal and/or metal oxide(s)is/are chosen from silicon dioxide, aluminum oxide, zirconium dioxide, and any combination thereof.
12. The composition of clause 10, wherein the metal(s) is/are chosen from stainless steel, copper, aluminum, titanium, and any combination thereof.
13. The composition of clause 10, wherein the flame retardant(s) is/are chosen from metal mono-, di-, and tri-hydroxide(s), metal organic phosphorus compound(s), and any combination thereof.
14. The composition of clause 13, wherein the flame retardant(s) is/are chosen from aluminum trihydroxide, aluminum diethyl phosphinate, melamine zinc polyphosphate, and any combination thereof.
15. The composition of any one of the preceding clauses, wherein at least one dispersant has a higher association affinity for nanoparticle-sized inorganic particles and at least one dispersant has a higher association affinity for microparticle-sized inorganic particles.
16. The composition of clause 15, wherein the at least one dispersant having a higher association affinity for nanoparticle-sized inorganic particles, and the at least one dispersant having a higher association affinity for microparticle-sized inorganic particles each individually comprise: a polar group selected based on the association affinity for the nanoparticle- or microparticle-sized inorganic particle; a nonpolar group selected for miscibility with the organic carrier fluid; and a linking group connecting the polar group and the nonpolar group.
17. The composition of clause 16, wherein the length of each dispersant is selected, at least in part, to increase steric hindrance between the inorganic particles.
18. The composition of clause 16, wherein the polar group(s) is/are independently chosen from alkoxysilane, poly(alkylene glycol), and phosphate ester polar group(s), wherein the nonpolar group(s)) is/are independently chosen from alkyl and vinyl nonpolar group(s), and/or wherein the linking group of the dispersant(s) and/or the surfactant(s) is/are independently chosen from aryl ether and alkyl ester linking group(s).
19. The composition of any one of the preceding clauses, wherein at least one dispersant is selected to stabilize electrostatic and/or steric repulsion of the inorganic particles and/or other dispersants, optionally a phosphodiester polymer.
20. The composition of clause 15, further comprising one or more surfactants.
21. The composition of any one of the preceding clauses, wherein the composition comprises a weight ratio of the inorganic particles to the dispersant(s) of from about 1/1 to about 10/1, from about 2/1 to about 8/1, or from about 4/1 to about 6/1.
22. The composition of clause 1, wherein the carrier fluid comprises one or more organic monomer(s), one or more organic oligomer(s), or any combination thereof.
23. The composition of anyone of the preceding clauses, wherein the composition is photocurable and further comprises one or more photo-initiators.
24. The composition of any one of clauses 23, further comprising one or more photo-stabilizers.
25. The composition of any one of clauses 1 to 22, wherein the composition is thermocurable and comprises one or more thermal initiators.
26. The composition of any one of the preceding clauses further comprising one or more defoamer(s).
27. The composition of any one of the preceding clauses further comprising one or more pigments or coloring agent.
28. A highly dispersed, highly filled, low viscosity resin composition comprising: a) a non-polar organic carrier fluid comprising curable organic monomers, curable organic oligomers, or combinations thereof, b) a plurality of nanoparticle- and microparticle-sized inorganic particles comprising between at least 30 wt. % to about 90 wt. % based on the total weight of the composition; and c) multiple dispersants comprising a methylacrylated silane, a polyethylene glycol and a phosphodiester polymer; and wherein the composition has a viscosity from about 200 cP to about 1000 cP at 25o C and is substantially or completely free of water or other solvents and diluents.
29. The composition of clause 28, wherein the non-polar organic carrier comprises CFTA, HDDA, vinylmethoxysiloxane, or a combination thereof.
30. The composition of clause 29, wherein the plurality of inorganic particles comprise ceramics or precursors thereof and further comprising an acrylic monomer.
31. The composition of clause 30, wherein the ceramic precursors comprise silicon dioxide, aluminum oxide, zirconium dioxide, and any combination thereof.
32. The composition of clause 29, wherein the plurality of inorganic particles comprises one or more nonmetal oxide(s), one or more metal oxide(s), one or more flame retardant(s), one or more metal(s), or any combination thereof.
33. The composition of clause 31 or 32, wherein the nano-sized inorganic particles are fumed silicone dioxide and wherein the micro-sized inorganic particles are fused silicon dioxide in crystalline form and having a spherical geometric shape, optionally 2-6 mm in diameter.
34. The composition of any one of clauses 28 to 33, wherein the composition comprises a weight ratio of the phosphodiester polymer to a poly(ethylene glycol) of from at least about 1/1 to at least about 10/1, from at least about 1/1 to at least about 6/1, or from at least about 1/1 to at least about 2.5/1; and/or at least 60 wt. % to at least 95 wt. % of methacrylated silane based on the total weight of the dispersant.
35. A method of making an object, the method comprising: forming one or more layer(s) comprising one or more compositions(s) of any one of clauses 1-34; optionally mixing, dispersing, and/or milling the composition(s) prior to and/or during the forming of one or more or all of the layer(s); solidifying the layer(s); and optionally, sintering the solidified layer(s), wherein an object is formed.
36. The method of clause 35, wherein the forming the layer(s) comprises coating or printing the composition(s) in the form of one layer and, optionally, repeating the coating or the printing the composition(s) to form multiple layers.
37. The method of clause 35 or clause 36, wherein the step of forming the one or more layer(s) comprises vat polymerization three-dimensional (3D) printing.
38. The method of any one of clauses 35-37, wherein the solidifying the layer(s) comprises thermal curing or ultra-violet (UV) radiation curing of the layer(s).
39. The method of any one of clauses 35-38, wherein the object comprises inorganic-polymer composite(s), metal-polymer composite(s), flame retardant-polymer composite(s), ceramic(s), metal(s), or any combination thereof.
40. An object, wherein the object comprises one or more composition(s) of any one of clauses 1-34 and/or wherein the object is prepared by the method of any one of clauses 35-39.
41. The object of clause 40, wherein the object is in the form of a coating, a sheet, a film, a fiber, a textile, a solid article, a hollow article, a foam, or a composite.
42. The object of clause 40 or clause 41, wherein the object is a consumer product, an industrial product, a medical product or device, an architectural part, an automotive part, an aviation part, a construction part, or an electronics part.

Further embodiments are illustrated in the following Examples which are given for illustrative purposes only and are not intended to limit the scope of the invention.

### EXAMPLES

### Example 1—Low Viscosity, High-Solids 3D Printable Resins

Fluid Selection. Table 1 shows representative examples of monomers and oligomers that can be used to prepare low-viscosity, high-solids compositions.

TABLE 1
Monomer or Oligomer

Cyclic Trimethylolpropane Formal Acrylate (CTFA)
1,6-Hexanediol diacrylate (HDDA)
Vinylmethoxysiloxane

Particle Selection. Table 2 shows representative examples of particles that can be used to prepare low-viscosity, high-solids compositions.

TABLE 2
Particle

Aluminum Oxide (Al₂O₃)
Silicon Dioxide (SiO₂)
Zirconium Dioxide (ZrO₂)
Aluminum Trihydroxide
Aluminum Diethyl Phosphinate
Melamine poly(zinc phosphate)
Stainless Steel
Copper
Aluminum
Titanium

Dispersant and Surfactant Selection. Table 3 shows representative examples of dispersants and surfactants that can be used to prepare low-viscosity, high-solids compositions.

TABLE 3

| Polar Group | Dispersant |
|---|---|
| PEG | PEG tert-octylphenyl ether |
| Alkoxysilane | Methacrylated silane |
| | (3-Methacryloxypropyltrimethoxysilane) |
| Phosphoester | Phosphodiester polymer |

Additive Selection. Table 4 shows representative examples of additives that can be used to prepare low-viscosity, high-solids compositions.

TABLE 4

| Additive Type | Chemical Name |
|---|---|
| Photo-Initiator | Ethyl (2,4,6-trimethylbenzoyl) phenylphosphinate |
| Photo-Initiator | Diphenyl(2,4,6-trimethylbenzoyl)phosphine oxide |
| Photo-Initiator | Bis-acylphosphine oxide |
| UV-Blocker | polycyclic aromatic hydrocarbon |
| Thermal Initiator | 2,5-dimethyl-2,5-di-(tert-butylperoxy)-hexane |
| Defoamer | Decene, homopolymer, hydrogenated |

Formulation of Low Viscosity, High-Solids 3D Printable Resins. A representative example of a method of formulating low viscosity, high-solids 3D printable resins of the present invention is shown below:
Dispersant(s) and/or surfactant(s) comprising PEG and/or phosphoester polar groups are added to monomer(s) and/or oligomer(s) to form a reaction mixture;
Optionally, nano-sized particle(s), optionally pre-dispersed in monomer(s) and/or oligomer(s), are added to the reaction mixture;
Micro-sized particle(s) are incrementally added to the reaction mixture;
Dispersant(s) and/or surfactant(s) comprising alkoxysilane polar groups are added to the reaction mixture;
Nano-sized particle(s) are incrementally added to the reaction mixture;
Dispersant(s) and/or surfactant(s) comprising alkoxysilane polar groups are incrementally added to the reaction mixture;
Defoamer, any necessary initiators, any necessary stabilizers, any pigments, any other additives, and the like are added to the reaction mixture;
The reaction mixture is hand mixed for about 5 minutes after each addition. After the final hand mixing, the reaction mixture is further ball milled for about 24 hours.

Viscosity Evaluations. Various compositions were prepared according to the previous formulation procedure and the viscosities of the compositions were evaluated by methods disclosed herein. The effect of additives such as initiators, stabilizers, and defoamers had a negligent effect on viscosity as they were added at very low amounts. Due to a wide range of experiments and formulations and material libraries, the range of individual components was significantly broad. The selected oligomers and monomers as well as the selected particles and particle sizes had the greatest effect on the final viscosities of the compositions.

Effect of Dispersant and Surfactant. Ranges for viscosity of the composition as a function of the types and amounts of dispersant(s) and/or surfactant(s) are listed in Table 5. Note: the viscosity difference when using HDDA vs. CTFA was minimal; the methacrylated silane content was consistent throughout the most relevant formulations; a 2.5 weight ratio of microparticles to nanoparticles was used; crystalline, spherical microparticles were used.

TABLE 5

| | PEG | | |
|---|---|---|---|
| | tert-octylphenyl | Phosphodiester | Methacrylated |
| Viscosity | ether | Polymer | Silane |
| (cP) | wt. %* | wt. %* | wt. %* |
| 350-370 | 3 | 0 | 10 |
| 370-380 | 1.5 | 0 | 10 |
| 600 | 0 | 0.6 | 10 |
| 450 | 0 | 0.8 | 10 |
| 544-618 | 0 | 1.0 | 10 |
| 770-860 | 0 | 1.5 | 10 |
| 1000 | 0 | 2.0 | 10 |
| 365 | 0.4 | 0.8 | 10 |

*based on the total weight of the composition.

Effect of Microparticle to Nanoparticle Weight Ratio on Viscosity. Values for viscosity of the composition as a function of the types and amounts of particles are listed in Table 6. Note: CTFA was used as monomer; 0.4 wt. % PEG tert-octylphenyl ether, 0.8 wt. % phosphodiester polymer, and 10 wt. % methacrylated silane were used; crystalline, spherical microparticles were used.

TABLE 6

| Viscosity | Nanoparticles | Microparticles |
|---|---|---|
| (cP) | wt. %* | wt. %* |
| 546 | 23.25 | 50 |
| 375 | 20 | 50 |

*based on the total weight of the composition

Effect of Monomer or Oligomer on Viscosity. Values for viscosity of the composition as a function of the Monomer or Oligomer type are listed in Table 7. Note: 3% PEG tert-octylphenyl ether, 0% phosphodiester polymer, and 10 wt. % methacrylated silane were used; a 5:2 weight ratio of microparticles to nanoparticles was used; crystalline, spherical microparticles were used.

TABLE 7

| Viscosity (cP) | Monomer or Oligomer |
|---|---|
| 375 | CTFA |
| 365 | HDDA |
| 530 | Vinylmethoxysiloxane |

Viscosity Test Procedures. A digital rotational viscometer having continuous sensing capability was used for rapid measurement of viscosity and temperature (using a temperature probe) simultaneously. Viscosity could be measured at different speeds with different size spindles depending on the viscosity of the material.

In a typical viscosity measurement, a spindle attached to the viscometer is submerged into a container of material being tested. Once the motor is turned on, the spindle begins to turn in the material at a selected rotations per minute (RPM). A temperature probe is simultaneously placed in the material to record temperature. Viscosity, RPM, torque, temperature, and time allotted are recorded. Typically, the viscosity is tested at 3 different RPMS (100, 50 and 20 RPM) to analyze the change in viscosity and Newtonian properties.

Stability Evaluations. Compositions were observed to be stable to separations/conglomerate due to the high loading of particles for several days to several weeks. Re-mixing, re-dispersing, and/or re-milling successfully returned the compositions to uniform dispersions.

Formation of 3D printed parts. Compositions prepared according to the disclosed procedure were used in a vat polymerization 3D printer. 3D parts were successfully cast and mechanically tested. The 3D parts demonstrated consistent UV reactivity data, suggesting that the compositions were uniformly dispersed during the printing and curing process.

Various modifications and variations of the described methods, pharmaceutical compositions, and kits of the invention will be apparent to those skilled in the art without departing from the scope and spirit of the invention. Although the invention has been described in connection with specific embodiments, it will be understood that it is capable of further modifications and that the invention as claimed should not be unduly limited to such specific embodiments. Indeed, various modifications of the described modes for carrying out the invention that are obvious to those skilled in the art are intended to be within the scope of the invention. This application is intended to cover any variations, uses, or adaptations of the invention following, in general, the principles of the invention and including such departures from the present disclosure come within known customary practice within the art to which the invention pertains and may be applied to the essential features herein before set forth.

1. A highly dispersed, highly filled, low viscosity liquid composition comprising a non-polar organic carrier fluid, a plurality of nano- and micro-sized inorganic particles, and multiple dispersants, at least a portion of which exhibit different association affinities for inorganic particles of a particular size or size range, and wherein the composition is substantially or completely free of water or other solvents and diluents.

2. The composition of claim 1, wherein the composition comprises between at least about 30 weight % (wt. %) to about 90 wt. % of the plurality of inorganic particles based on the total weight of the composition and a viscosity of from about 200 centipoise (cP) to about 1000 cP at 250° C.

3. The composition of claim 2, wherein the viscosity of the composition is from about 300 cp to about 500 cp at 25° C.

4. The composition of claim 1, wherein the composition comprises a weight ratio of the micro-sized inorganic particles to the nano-sized inorganic particles of from at least about 1/1 to at least about 10/1, from at least about 1/1 to at least about 6/1, or from at least about 1/1 to at least about 2.5/1.

5. The composition of claim 1, wherein the plurality of nano- and micro-sized inorganic particles comprise a substantially spherical geometric shape and at least at least a portion of which are in crystalline form.

6. The composition of claim 1, wherein the micro-sized inorganic particles comprise an average particle size of from about 0.1 micron (mm) to about 100 mm, from about 0.25 mm to about 75 mm, from about 0.5 mm to about 50 mm, from about 0.75 mm to about 25 mm, from about 1 mm to about 10 mm, or from about 1 mm to about 20 mm; and the nano-sized inorganic particles comprise an average particle size of from about 0.1 nanometers (mm) to about 150 nm, from about 0.25 nm to about 100 nm, from about 0.5 nm to about 50 nm, from about 0.75 nm to about 40 nm, from about 1 nm to about 30 nm, or from about 10 nm to about 40 nm.

7. The composition of claim 1, wherein the nano-sized and the micro-sized inorganic particles independently comprise one or more ceramic(s) or precursor(s) thereof, optionally wherein the one or more ceramic(s) comprise, silicon dioxide, aluminum oxide, zirconium dioxide, or any combination thereof, optionally further comprising acrylate monomers.

8. (canceled)

9. (canceled)

10. The composition of claim 1, wherein the nanoparticle- and the microparticle-sized inorganic particles independently comprise(s) one or more nonmetal oxide(s), one or more metal oxide(s), one or more flame retardant(s), one or more metal(s), or any combination thereof, optionally wherein,
the nonmetal and/or metal oxide(s) is/are chosen from silicon dioxide, aluminum oxide, zirconium dioxide, and any combination thereof; or
the metal(s) is/are chosen from stainless steel, copper, aluminum, titanium, and any combination thereof; or
the flame retardant(s) is/are chosen from metal mono-, di-, and tri-hydroxide(s), metal organic phosphorus compound(s), and any combination thereof, optionally wherein the flame retardant(s) is/are chosen from aluminum trihydroxide, aluminum diethyl phosphinate, melamine zinc polyphosphate, and any combination thereof.

11. (canceled)

12. (canceled)

13. (canceled)

14. (canceled)

15. The composition of claim 1, wherein at least one dispersant has a higher association affinity for nanoparticle-sized inorganic particles and at least one dispersant has a higher association affinity for microparticle-sized inorganic particles, optionally wherein the at least one dispersant having a higher association affinity for nanoparticle-sized inorganic particles, and the at least one dispersant having a higher association affinity for microparticle-sized inorganic particles each individually comprise: a polar group selected based on the association affinity for the nanoparticle- or microparticle-sized inorganic particle: a nonpolar group selected for miscibility with the organic carrier fluid; and a linking group connecting the polar group and the nonpolar group, optionally wherein the length of each dispersant is selected, at least in part, to increase steric hindrance between the inorganic particles, optionally wherein the polar group(s) is/are independently chosen from alkoxysilane, poly(alkylene glycol), and phosphate ester polar group(s), wherein the nonpolar group(s)) is/are independently chosen from alkyl and vinyl nonpolar group(s), and/or wherein the linking group of the dispersant(s) and/or the surfactant(s) is/are independently chosen from aryl ether and alkyl ester linking group(s).

16. (canceled)

17. (canceled)

18. (canceled)

19. The composition of claim 1, wherein at least one dispersant is selected to stabilize electrostatic and/or steric repulsion of the inorganic particles and/or other dispersants, optionally a phosphodiester polymer, optionally further comprising one or more surfactants.

20. (canceled)

21. The composition of claim 1, wherein the composition comprises a weight ratio of the inorganic particles to the dispersant(s) of from about 1/1 to about 10/1, from about 2/1 to about 8/1, or from about 4/1 to about 6/1.

22. The composition of claim 1, wherein the carrier fluid comprises one or more organic monomer(s), one or more organic oligomer(s), or any combination thereof.

23. The composition of claim 1, wherein the composition is photocurable and further comprises one or more photo-initiators, optionally further comprising one or more photo-stabilizers: or the composition is thermocurable and comprises one or more thermal initiators.

24. (canceled)

25. (canceled)

26. The composition of claim 1 further comprising one or more defoamer(s), optionally further comprising one or more pigments or coloring agent.

27. (canceled)

28. A highly dispersed, highly filled, low viscosity resin composition comprising:
a) a non-polar organic carrier fluid comprising curable organic monomers, curable organic oligomers, or combinations thereof;
b) a plurality of nanoparticle- and microparticle-sized inorganic particles comprising between at least 30 wt. % to about 90 wt. % based on the total weight of the composition; and
c) multiple dispersants comprising a methylacrylated silane, a polyethylene glycol and a phosphodiester polymer; and
wherein the composition has a viscosity from about 200 cP to about 1000 cP at 250° C. and is substantially or completely free of water or other solvents and diluents.

29. The composition of claim 28, wherein
the non-polar organic carrier comprises CFTA, HDDA, vinylmethoxysiloxane, or a combination thereof; or
the plurality of inorganic particles comprises ceramics or precursors thereof and further comprising an acrylic monomer, optionally the ceramic precursors comprise silicon dioxide, aluminum oxide, zirconium dioxide, and any combination thereof; or
the plurality of inorganic particles comprises one or more nonmetal oxide(s), one or more metal oxide(s), one or more flame retardant(s), one or more metal(s), or any combination thereof; or
the nano-sized inorganic particles are fumed silicone dioxide and wherein the micro-sized inorganic particles are fused silicon dioxide in crystalline form and having a spherical geometric shape, optionally 2-6 mm in diameter.

30. (canceled)

31. (canceled)

32. (canceled)

33. (canceled)

34. The composition of claim 28, wherein the composition comprises a weight ratio of the phosphodiester polymer to a poly(ethylene glycol) of from at least about 1/1 to at least about 10/1, from at least about 1/1 to at least about 6/1, or from at least about 1/1 to at least about 2.5/1; and/or at least 60 wt. % to at least 95 wt. % of methacrylated silane based on the total weight of the dispersant.

35. A method of making an object, the method comprising:
forming one or more layer(s) comprising one or more compositions(s) of claim 1;
optionally mixing, dispersing, and/or milling the composition(s) prior to and/or during the forming of one or more or all of the layer(s);
solidifying the layer(s); and
optionally, sintering the solidified layer(s),
wherein an object is formed.

36. The method of claim 35, wherein
the forming the layer(s) comprises coating or printing the composition(s) in the form of one layer and, optionally, repeating the coating or the printing the composition(s) to form multiple layers; or
the step of forming the one or more layer(s) comprises vat polymerization three-dimensional (3D) printing: or
the solidifying the layer(s) comprises thermal curing or ultra-violet (UV) radiation curing of the layer(s).

37. (canceled)

38. (canceled)

39. The method of claim 35, wherein the object comprises inorganic-polymer composite(s), metal-polymer composite(s), flame retardant-polymer composite(s), ceramic(s), metal(s), or any combination thereof.

40. An object, wherein the object comprises one or more composition(s) of claim 1, optionally wherein the object is in the form of a coating, a sheet, a film, a fiber, a textile, a solid article, a hollow article, a foam, or a composite, optionally wherein the object is a consumer product, an industrial product, a medical product or device, an architectural part, an automotive part, an aviation part, a construction part, or an electronics part.

41. An object, wherein the object is prepared by the method of claim 35, optionally wherein the object is in the form of a coating, a sheet, a film, a fiber, a textile, a solid article, a hollow article, a foam, or a composite, optionally wherein the object is a consumer product, an industrial product, a medical product or device, an architectural part, an automotive part, an aviation part, a construction part, or an electronics part.

42. (canceled)
